(19) United States
(12) Patent Application Publication
(10) Pub. No.: US 2024/0283044 A1
(43) Pub. Date: Aug. 22, 2024

(54) Process for Recycling Battery Materials By Way of Hydrometallurgical Treatment

(71) Applicant: H. C. Starck Tungsten GmbH, Goslar (DE)

(72) Inventors: Juliane Meese-Marktscheffel, Goslar (DE); Armin Olbrich, Seesen (DE); Alexander Wolff, Hildesheim (DE); Alexander Zeugner, Wolfenbüttel (DE); Alexander Egeberg, Goslar (DE); Tino Saeuberlich, Bad Harzburg (DE)

(21) Appl. No.: 18/570,213

(22) PCT Filed: Jun. 21, 2022
(86) PCT No.: PCT/EP2022/066855

§ 371 Date: Dec. 14, 2023

(30) Foreign Application Priority Data
Jun. 23, 2021 (EP) 21181175.7

(51) Int. Cl. H01M 10/54; C22B 3/00; C22B 3/26; C22B 3/44; C22B 5/04; C22B 5/08; C22B 5/10; C22B 26/12

(52) U.S. Cl. CPC H01M 10/54; C22B 3/26; C22B 3/44; C22B 5/04; C22B 5/08; C22B 5/10; C22B 23/0461; C22B 26/12

(57) ABSTRACT

The present invention relates to a process for recycling battery materials, in particular lithium ion/polymer batteries, and to the subsequent use of the useful materials recovered by way of the process according to the invention.

The present invention relates to a recycling method for battery materials, in particular lithium-ion/polymer batteries, and the further use of the valuable materials recovered by the method according to the invention.

Electromobility is considered as a central component of a sustainable and climate-friendly transport system based on renewable energies and belongs to the global megatrend “Advanced Mobility”, which is not only discussed intensively in society and politics, but now also present in the industry. The electromobility includes all types of electric vehicles: electric bicycles, motorcycles, forklifts, ferries and sport boats, hybrid cars, plug-in cars and fully electric cars up to electric buses and hybrid or fully electric trucks. For the time being, batteries, in particular the so-called lithium-ion/polymer accumulators (hereinafter referred to as LIB), have established themselves as energy storage in this context.

With the increasing demand for electric vehicles, not only the need for corresponding drive and energy storage systems increases. The question also arises as to how these systems can be integrated into a clean and circular economy, which will certainly continue to gain importance in the future from the perspective of sustainability. Therefore, the strategic relevance of the recycling of these systems is an essential component in the entire value chain of the global megatrend of mobility and thus an indispensable part of international efforts to achieve climate goals. Therefore, it is absolutely necessary to be able to provide key materials for electromobility as quickly as possible through environmentally friendly, energy and cost-efficient and socially compatible recycling processes. The emancipation from the classic primary raw material recovery of battery-relevant materials towards the sustainable and nevertheless economical handling of them through the development and large-scale implementation of innovative recycling processes will increasingly come to the fore globally.

Typical elements, that are used in LIB in metallic form or in the form of their compounds, are iron (Fe), aluminum (Al) and copper (Cu), manganese (Mn), nickel (Ni) and cobalt (Co), lithium (Li) as well as graphite in various modifications, which mainly make up parts of the housing, the electrical supply lines, but also especially the electrode materials and, depending on the battery type, battery model and battery design, can occur in a wide variety of proportions in addition to the minor electrolyte and separator materials. Some of these raw materials are often recovered under precarious conditions that are associated with far-reaching social and environmental impacts. In this context, it should pay attention to, for example, the existence of child labor e.g. in the manual mining of cobalt or the extremely dubious influence of lithium recovery on the water balance in desert areas and plateaus from an environmental point of view. In view of the massive social and ecological impacts associated with the steadily increasing demand for these strategic raw materials, the recycling of LIBs and related systems plays a key role in the sustainable transition to alternative energy storage systems, as explained above. Due to the complexity of the material compositions and the use of substances and mixtures classified as carcinogenic and their electrical and chemical energy content, the recycling of LIBs is not only a purely technological challenge, but also associated with a number of health, safety and environmental risks to be controlled.

Initial attempts to establish a closed cycle for LIBs resulted in various recycling processes that have so far only been implemented in a few industrial plants around the world. All of these methods are characterized by long and costly process chains and based on a combination of mechanical and/or thermal and/or pyrometallurgical and hydrometallurgical process steps. An overview of the common processes is provided by L. Brückner et al in their review article: “Industrial Recycling of Lithium-Ion Batteries—A Critical Review of Metallurgical Process Routes”, published in Metals 2020, 10, 1107.

Within the framework of the following statements and the present invention, no distinction is made between the systems lithium batteries, rechargeable lithium batteries and lithium accumulators, rechargeable lithium-ion batteries and lithium-ion accumulators and rechargeable lithium-polymer batteries and lithium-polymer accumulators. All systems are hereby considered to be synonymous with one another and summarized under the designation “LIB”, unless expressly stated otherwise.

Currently, two variants for recycling LIBs have been established, the first bases on a combination of pyrometallurgical and hydrometallurgical treatments, whereas the second bases on mechanical treatment, possibly with an upstream or downstream thermal stage, prior to the actual hydrometallurgical further processing.

In the case of a pyrometallurgical treatment of used LIBs or residues from battery production, as it is carried out in the first variant described, molten alloys containing Co, Cu and Ni (metallic phase), an liquid slag containing Al, Mn and Li and fly ash appear. The metallic phases and the slag can then be further treated hydrometallurgically in order to obtain the individual metals using known methods via multi-stage processes.

Within the framework of the second variant described, the LIBs are first treated mechanically, whereby typically magnetic and non-magnetic metal concentrates such as Al and Cu concentrates as well as a fraction appear, that contains the active electrode materials, the so-called black mass. The mechanical treatment can optionally be preceded by a thermal treatment in order to reduce the energy content in a controlled manner and to remove organic components and halides in a targeted manner. Particularly with larger traction batteries, an upstream electrical residual discharge of the LIBs can also be advantageous for safety reasons. The black mass resulting from these processes can then either be fed to a pyrometallurgical treatment, in accordance with the first variant described, or, which is preferred, be subjected directly to a hydrometallurgical treatment. Depending on the composition of the black mass and the upstream treatment procedure practiced in each case, a thermal treatment can now also be advantageous in order to remove organic components and halides present at this point and to increase the metal content. During the hydrometallurgical treatment, Co, Li, Mn, Ni and, if available, graphite can be recovered.

The following is an example of the processing of used LIBs based on the second variant, as known in the state of the technology:

The mechanical treatment of the disused LIBs usually begins with a crushing in order to release the components of the LIBs. With large batteries from electric drives, an electrical deep discharge is advantageous. The components can then be sorted by their physical properties, such as by particle size, shape, density and electrical and magnetic properties. Usually, the crushing process produces concentrates for further metallurgical processes.

Pyrometallurgy includes high-temperature processes such as roasting or melting for the separation, recovery and refinement of metals. The term roasting is generally understood to mean processes such as gas-solid reactions, with which ores or secondary raw materials can be converted into other, more easily processed chemical substances or mixtures, whereby some of the undesirable components can often be removed in gaseous form. During smelting, the metal is extracted from the ore or the secondary raw material with the help of heat and chemical reducing agents, whereby the ore or the secondary raw material is decomposed and other elements are expelled in the form of gas or captured or accumulated in slag in order to get alloys or, in the best case, pure metal.

“Hydrometallurgy” refers to the entirety of the methods in metal recovery and refining, which, in contrast to pyrometallurgy, take place at comparatively low temperatures in solution. Hydrometallurgical methods usually involve several steps. In a first step, the metal is first brought into solution by leaching, usually with the help of acids, bases or salts. In a subsequent step, cleaning takes place, for example with the help of liquid/solid reactions such as ion exchange reactions and precipitation or liquid/liquid reactions such as solvent extraction. In a final step, the valuable material element initially in solution is precipitated, either directly as a metal or as a chemical compound, often in salt form, for example by crystallization, ionic precipitation, reduction with gases, electrochemical reduction or electrolytic reduction.

Like other battery types, LIBs are usually made up of a cathode, an anode, an electrolyte and a separator, whereby the components can vary depending on the battery type and manufacturer and therefore have a large influence on possible recycling processes.

Commercially high-performance cathode materials in LIBs are typically LiCo oxides (LCO), Li (Co/Ni) oxides (LCNO), Li (Ni/Co/Mn) oxides (LNCMO), Li (Ni/Co/Al) oxides (LNCAO) or Li (Ni/Al) oxides (LNAO) in the form of LiMO₂ layer structures (with M=Ni, Co and/or Mn), which can optionally be doped with Al for stabilization, or Li (Ni/Mn) oxides in the form of LiM₂O₄ spinel structures, whereby only the main components essential for recovery from a supply engineering and economic point of view are mentioned here. There is also a variety of other doping elements, which, depending on the battery or cathode material manufacturer and the respective uses of the rechargeable batteries, extend over various other subgroup metals, including the rare earth elements, but also main group elements of the periodic system.

Furthermore, Li-metal-phosphates of the structure LIMPO₄ (M=Fe, Mn, Co, Ni), also in variously doped form, can be used, but due to their usually high content of less valuable iron and phosphorus, the main component LiFePO₄ in the desired recycling processes play a subordinate role.

The most common cathode materials known from the literature are as layer structures LCO (LiCOO₂), NMC (LiNiₓMn_{y}CO₂O₂ with x+y+z=1), NCA (LiNiₓCO_{y}Al₂O₂ with x+y+z=1, especially LiNi_{0.8}CO_{0.15}Al_{0.05}O₂) as well as spinel LiMn₂O₄ and LFP (LiFePO₄), which has an olivine structure, whereby the places of the SiO₄ tetrahedra in the olivine ((Mg, Fe)₂SiO₄) are occupied by PO₄ tetrahedra.

Due to their high content of aluminum, which comes mainly from the housing, and significant amounts of lithium and organic compounds only to a limited extent as starting material for classic smelting processes as they are used for the recovery of Co, Ni or Cu, so-called end-of-life LIBs to be recycled or waste from LIB production (off-spec) are suitable, as in particular lithium is known to attack the furnaces. Another problem is that the established processes concentrate on the recovery of Co, Cu and Ni and that lithium, together with aluminum and manganese only occurs in low concentrations in the form of slag, from which it is difficult to remove.

In order to address these problems, a number of processes have been developed that focus specifically on the treatment of LIBs. These processes allow lithium to accumulate in the slag and use special furnaces that are designed for highly corrosive materials.

In this context, U.S. Pat. No. 7,169,206 describes a method for the recovery of Co or Ni, in which a metallurgical charge of iron, slag formers and a workload, which contains either nickel or cobalt or both, is brought into a shaft furnace and melted, whereby a Co/Ni alloy, a ferrous slag and a gas phase occur. The workload comprises at least 30% by weight of batteries or their scrap, and the redox potential of the shaft furnace is selected in such a way that the slag contains at least 20% by weight of iron and a maximum of 20% by weight of the nickel and/or cobalt of the workload. Although LIBs are mentioned as suitable starting materials, no further details are given as to whether and in what amount lithium could be recovered.

EP 2 480 697 also describes a method for the recovery of Co from Li-ion batteries, which also contain Al and C, comprising the steps: Providing a bath furnace which is equipped with means for injecting O₂; Providing a metallurgical charge comprising Li-ion batteries and at least 15% by weight of a slag former; Supplying the metallurgical charge to the furnace with injection of O₂, whereby at least a part of the Co in a metallic phase is reduced and collected; Separating the slag from the metallic phase, whereby the process is carried out under autogenous conditions by adding the proportion of Li-ion batteries, expressed in % by weight of the metallurgical load, equal to or greater than 153%−3.5 (Al %+0.6 C %), whereby Al % and C % are the % by weight of Al and C in the batteries. It can be seen from the examples that the slag obtained also contained Li, but no further treatment of the slag to isolate the lithium is described.

WO 2011/141297 describes a method for the production of lithium-containing concrete, in which lithium-containing metal scrap is melted to obtain a metallic phase and a lithium-containing slag, the slag is separated from the metallic phase, the slag is solidified by cooling and then the slag is processed into a powder with a particle size D90 of less than 1 mm. The pulverized slag is then added to concrete or mortar in order to prevent undesirable ASR (alkali-silica reactions), whereby the lithium is finally extracted from the material cycle.

Further investigations have shown that the lithium content of the slag recovered is comparable to that of spodumene concentrates, which, in addition to lithium-containing brine, are the largest commercial lithium source in the field of primary raw materials containing lithium. Within the framework of various research work, methods for the extraction of lithium from slags of different compositions have been developed. In a first step, the slag was ground to a powder on a micrometer scale and then leached with H₂SO₄ or HCl at 80° C., whereby an acid concentration of around 10 g/L has proven advantageous. In order to separate aluminum, the pH value of the leaching solution was then adjusted to pH 5 and aluminum hydroxide precipitated. After filtration and concentration of the lithium content in the leaching solution, the lithium was then precipitated as lithium carbonate at pH 9 to 10 with the help of Na₂CO₃. Under optimized conditions, a lithium yield of 60 to 70% could be achieved. However, the method shows the disadvantage that the low lithium content in the slag results in a high proportion of waste and the Li₂CO₃ obtained has a high level of impurities.

An alternative recycling method for LIBs is based on a combination of mechanical treatment and pyrometallurgical and/or hydrometallurgical treatment, in which a certain fraction, the so-called black mass, is in the foreground. In an optional pretreatment, the LIBs are subjected to thermal treatment, for example pyrolysis, in order to reduce the energy content in a controlled manner and to remove organic components. After the material obtained has been crushed, it can be separated by sieving, sorting or magnetically, whereby as typical fractions, Al/Cu foils, non-magnetic metals such as aluminum or copper in pieces or powder form, magnetic metals and a fraction known as black mass, which are essentially made of the active materials of the batteries, i.e. the cathode material with the main components Ni, Co, Mn, Al and Li as well as optionally graphite from the anode material, can be isolated. With the exception of the black mass, all fractions obtained can be fed to conventional treatment processes.

Due to its already reduced aluminum content, the black mass is better suited for conventional pyrometallurgical processes than LIBs. Due to the corrosive properties of lithium and the costly reprocessing of the lithium-containing slag and the high losses of lithium during the reprocessing, the problem of efficient recovery of lithium in this way remains unsolved.

WO 2017/121663 relates to a lithium-containing slag, which shows 3 to 20% by weight of Li₂O, 1 to 7% by weight of MnO, 38 to 65% by weight of Al₂O₃, less than 55% by weight of CaO and less than 45% by weight of SiO₂. The lithium-containing slag can be obtained by melting battery materials, in which it is obtained together with a metallic phase. For this purpose, used lithium-ion batteries are added into a furnace together with limestone (CaCO₃) and sand (SiO₂) in the presence of oxygen. Due to the high content of metallic aluminum and carbon in the batteries, a temperature of 1400 to 1700° C. is reached. The resulting alloy melt and the slag are separated and the lithium is isolated from the slag. Although more than 50% of the lithium should accumulate in the slag, it could not be prevented that part of the lithium is discharged together with the exhaust gases. According to the amounts of battery material used according to the examples, the expert would expect a content of 12.42% Li₂O in the slag, but in fact table 1 only gives a content of recovered lithium of 8.4%, so that a loss of 32.4% of the lithium used is to be booked.

On the hydrometallurgy side, the focus is currently on two alternatives. The first alternative attempts to obtain intermediate products by leaching and precipitation, in which Ni/Co and manganese and lithium can then be purified separately from one another in existing refineries. The second alternative provides for a direct production of more complex products. Both methods provide for a step-by-step separation of the elements, in which manganese, cobalt and nickel are separated one after the other and in a last step lithium is isolated in the form of Li₂CO₃. FIGS. 1 and 2 show an overview of the two methods.

WO 2018/184876 describes a method for the recovery of lithium from a lithium- and aluminum-containing metallurgical composition, comprising the steps: Leaching the metallurgical composition by bringing it into contact with an aqueous sulfuric acid solution at a pH of 3 or less, thereby obtaining a residue containing insoluble compounds, and a first leachate comprising lithium and aluminum; Optionally neutralizing the first leachate comprising lithium and aluminum to a pH of 2 to 4, thereby precipitating a residue comprising a first part of the aluminum and obtaining a second leachate comprising lithium; Adding a phosphate ion source to the first leachate comprising lithium and aluminum, or, with the proviso that the optional neutralization of the first leachate is carried out, to the second leachate comprising lithium and aluminum, thereby precipitating a residue comprising the second part of the aluminum and obtaining a third leachate comprising lithium; Optionally neutralizing the third leachate comprising lithium and aluminum to a pH of 3 to 4, thereby precipitating a residue comprising a third part of the aluminum and obtaining a fourth leachate comprising lithium; and separating the residue comprising the second part of the aluminum from the third leachate by filtration, or, with the proviso that the optional neutralization of the third leachate is carried out, separating the residue comprising the third part of the aluminum from the fourth leachate by filtration. The lithium can then be obtained in the form of Li₂CO₃ with the help of known methods such as classic carbonate precipitation. In this way, a better separation of aluminum and lithium is to be achieved and the content of recovered lithium is to be increased.

WO 2019/149698 relates to a method for the recycling of lithium batteries, with the steps (a) digesting material to be crushed, which contains crushed components of electrodes of lithium batteries, with concentrated sulfuric acid at a digestion temperature (AT) of at least 100° C., so that an exhaust gas and a digestion material arise, (b) removal of the exhaust gas and (c) at least a wet chemical extraction of at least one metallic component of the digestion material.

WO 2020/109045 describes a process for the recovery of transition metals from batteries comprising treating a transition metal material with a leaching agent to extract soluble salts of nickel and cobalt, which may be reduced in a subsequent step by adding hydrogen. Soluble lithium salts can be separated from the transition metal material in an upstream washing step.

CN 111519031 discloses a method for recycling nickel, cobalt, manganese and lithium from used lithium-ion batteries, in which the used batteries are discharged and comminuted at first, and the thus obtained material is subsequently suspended in water. After the suspending, SO₂ is introduced, while at the same time concentrated sulfuric acid is added until a pH of 1 to 2 is reached. All metal compounds are dissolved thereby. Subsequently, transition metal compounds are precipitated by adding alkaline compounds, and consequently rising the pH, to obtain a lithium(I)-containing solution. The transition metal compounds subsequently have to be dissolved again with mineral acid.

In their paper “Organic oxalate as leachant and precipitant for the recovery of valuable metals from spent lithium-ion batteries”, issued in Waste Management 32 (2012), 1575-1582, L. Sun and K. Qiu describe a process for recovering cobalt and lithium from used batteries, in which processed battery waste is subjected to vacuum pyrolysis, followed by the addition of oxalate and H₂O₂, to recover cobalt as CoC₂O₄*2H₂O.

In “Lithium Carbonate Recovery from Cathode Scrap of Spent Lithium-Ion Battery: A Closed-Loop Process”, Environ. Sci. Technol. 2017, 51, 1662-1669, W. Gao et al. suggest a process for recovering lithium from batteries, in which the lithium is leached out using formic acid in the presence of H₂O₂.

The paper “Extraction of lithium from primary and secondary sources by pre-treatment, leaching and separation: A comprehensive review” in Hydrometallurgy 150 (2014), 192-208, offers a survey of the common methods for extracting lithium from primary sources, such as minerals, and secondary sources, such as used lithium batteries.

The methods described in the state of the technology show the disadvantage that the proportion of recovered lithium has so far been relatively low and the lithium is only separated as the last element, which on the one hand results in high losses and on the other hand, interferences from the lithium in the preceding method steps cannot be ruled out. An earlier extraction of lithium from the black mass is therefore of great interest.

In addition, there are currently no large-scale methods available that allow the efficient recovery of lithium from LIBs.

Conventional pyrometallurgical processes achieve high yields for Co, Cu and Ni in the alloy melts. However, lithium can only be recovered in special methods that require lithium to be concentrated in the slag. As a result, plants for the recovery of the valuable metals nickel, copper and especially cobalt, as they are currently used, have major disadvantages, if a certain recovery rate for lithium is prescribed by law, as expected after the reform of Directive 2006/66/EC, which regulates the legal foundations for the recycling of LIBs.

In hydrometallurgical processes, only small losses are observed for Co, Cu and Ni, but corresponding processes are not available for lithium. In the literature, possible recovery rates for Li from the slag are given with approximately 90%, but the total Li recovery is likely to be lower, as it is assumed that lithium is partially smoked in pyrometallurgy, as also described in WO 2017/121663.

Against this background, the present invention is based on the task of providing a method for recycling LIBs, which allows better recovery of the elements, in particular the active cathode material and in particular the lithium used. In particular, the method according to the invention should enable lithium to be separated off at the beginning of the reprocessing process, so that it does not have to be carried through the entire process chain.

Surprisingly, the present invention has shown that the previous problems in the recovery of lithium from LIBs can be overcome for the most part by separating lithium as one of the first elements, in contrast to the conventional methods, by means of a reductive treatment of a Li(I)-containing composition, without the formation of the usual melt phases.

Instead of dragging the lithium along through the entire processing and separation process, the method according to the invention provides for the separation of the lithium from the other metals nickel, cobalt and manganese at the beginning of the process chain. This could be achieved by the fact that a Li(I)-containing composition, unlike usual, is not subjected to a conventional pyrometallurgical treatment, which usually requires temperatures well above 1000° C. and provides liquid metal phases and liquid slag, but a reductive treatment in the solid state without the addition of slag formers. In this respect, the method according to the invention is distinguished in that a solid Li(I)-containing composition, for example in powder form, is subjected to a reductive treatment, whereby a lithium (I)-containing solution and again a solid, the reduced material, are obtained. In this way, the amount of lithium recovered could be increased significantly.

Therefore, a first subject matter of the present invention is a method for the recycling of LIB materials, comprising the following steps:
a) suspending a lithium(I)-containing composition in an aqueous or organic suspension medium,
b) treating the suspension with a reducing agent to simultaneously obtain a solid reduced material and a lithium (I)-containing solution and
c) separating the solid reduced material from the lithium (I)-containing solution.

Within the framework of the present invention, it has surprisingly been found that the reducing treatment can accumulate the lithium compounds contained in the composition in the suspension medium, whereas other components of the LIBs such as nickel, manganese and cobalt remain in the solid reduced material. The lithium(I)-containing solution and the reduced material can then be separated and reprocessed separately from one another. In contrast to the prior art, the transition metals are not dissolved together with the lithium in the process according to the invention, but remain in the solid reduced material. Another precipitation step for separating the transition metals, as described, for example, in CN 111519031, is omitted, so that the consumption of auxiliary substances and raw materials and the generation of neutral salts can also be decreased considerably. Therefore, the method according to the invention offers the possibility of separating lithium from the other components at the beginning of the recycling process, instead of carrying it along through the entire separation process of nickel, cobalt and manganese, as described in the state of the technology.

Within the framework of the present invention, a composition is understood to mean a lithium(I)-containing composition, unless stated otherwise.

Within the meaning of the present invention, reducing agent is understood to mean a substance or a compound, which can reduce other substances by donating electrons and is itself oxidized in the process, i.e. its oxidation number increases. This is in contrast to leaching, which is understood to mean the dissolving of substances from a solid by a solvent without changing the oxidation state.

Within the framework of the present invention, element as well as the general designation lithium, nickel, cobalt, manganese, etc. are understood as the general generic designation, which includes the elements in all of their oxidation numbers occurring within the framework of the method according to the invention, unless otherwise stated. For example, the term “nickel” includes nickel in the oxidation state+III, as it occurs, for example, in Li (Ni, Co, Mn) O₂, nickel in the oxidation state+II, as it occurs, for example, in NiO or Ni(OH)₂ and Nickel in the oxidation state 0, as it is in the form of nickel metal.

In the method according to the invention, unlike conventional methods, no liquid phases in the form of slag and alloy melt are formed. Rather, the method according to the invention is characterized in that both the composition used as the starting material and the reduced material obtained are in the form of powder, which significantly simplifies their handling. Therefore, in a preferred embodiment, the composition and/or the reduced material, in particular the reduced material, is in the form of a powder, preferably with a particle size of less than 200 μm, preferably less than 100 μm, determined in accordance with ASTM B822.

Further, within the framework of the method according to the invention, the use of slag formers or fluxes, as used in conventional methods, can advantageously be dispensed with. A preferred embodiment is therefore characterized in that the method is carried out without the addition of slag formers and/or fluxes.

The method according to the invention is distinguished in particular by the fact that the lithium is separated off first. The elements nickel, cobalt, manganese and optionally aluminum are only subjected to further separation into groups and finally into pure compounds of the individual elements only after they have been separated from the lithium. Therefore, an embodiment is preferred, in which the lithium is separated off from the composition before separating the nickel, cobalt, manganese and optionally aluminum. The lithium is preferably separated off from a suspension, which contains at least one of the elements nickel, manganese and cobalt as solid components.

The method according to the invention was developed primarily for the recycling of LIBs, both from corresponding end-of-life batteries and from off-spec materials, by-products and waste from the actual battery production. Therefore, an embodiment is preferred, in which the composition is obtained from, or consists of, used LIBs, production waste and secondary yields arising in the production of LIBs, in particular in the production of the electrode materials.

In a further preferred embodiment, the composition is obtained from used LIBs, preferably by pyrolysis. In a particularly preferred embodiment, the composition is lithium cathode materials, production waste from the production of lithium cathode materials and production waste from the production of lithium batteries/accumulators, in particular lithium-ion/polymer batteries, whereby the materials preferably are pyrolysed.

In a further preferred embodiment, the composition is black mass.

Within the framework of the present invention, black mass is understood to mean the fraction, that is obtained in the mechanical and possibly pyrolytic reprocessing of used LIBs, especially lithium batteries/accumulators, in particular lithium-ion/polymer batteries, waste from LIB production or raw material components and essentially contains the cathode materials, i.e. usually compounds of lithium with Co, Ni and/or manganese and their pyrolysis products, as well as graphite as anode material base. Typical compositions of the cathode materials are LiCo oxides (LCO), Li(Co/Ni) oxides (LCNO), Li(Ni/Co/Mn) oxides (LNCMO), Li(Ni/Co/Al) oxides (LNCAO), or Li(Ni/Al) oxides (LNAO) in the form of LiMO₂ layer structures with M=e.g. Ni, Co and/or Mn, optionally doped with Al, or Li(Ni/Mn) oxides in the form of LiM₂O₄ spinel structures or Li-metal phosphates LIMPO₄ (M=Fe, Mn, Co, Ni). Particularly common cathode materials are LCO (LiCoO₂), NMC (LiNiₓMn_{y}CO₂O₂ with X+y+z=1), NCA (with LiNiₓCo_{y}Al_{z}O₂ with x+y+z=1, especially LiNi_{0.8}CO_{0.15}Al_{0.05}O₂) and LiMn₂O₄ as spinel and LFP (LiFePO₄), which has an olivine structure.

In a preferred embodiment, the composition contains lithium or at least one of its compounds in an amount of 1 to 20% by weight, preferably 2 to 20% by weight, more preferably 2 to 15% by weight, especially 3 to 15% by weight, based on the total weight of the composition. The lithium is preferably in the oxidation state+I in the composition.

In addition, an embodiment is also preferred, in which the composition has at least one of the other elements in addition to lithium:
Aluminum, preferably in the oxidation state+III;
Cobalt, preferably in the oxidation state+II and/or +III;
Manganese, preferably in the oxidation state+II and/or +III;
Nickel, preferably in the oxidation state+II and/or +III;
   whereby the elements are present in the form of their oxides and/or in the form of mixed oxides among one another.

In a preferred embodiment, the composition has at least 1% by weight, preferably at least 3% by weight, more preferably at least 8% by weight, of cobalt, preferably in the oxidation state+III, based on the total weight of the composition.

In a preferred embodiment, the composition has at least 1% by weight, preferably at least 10% by weight, more preferably at least 15% by weight, of nickel, preferably in the oxidation state+III, based on the total weight of the composition.

In a preferred embodiment, the composition has at least 1% by weight, preferably at least 3% by weight, more preferably at least 8% by weight, of manganese, preferably in the oxidation state+III, based on the total weight of the composition.

In particular, the composition used according to the invention contains at least one of the compounds or is obtained preferably by means of pyrolysis from these, which is selected from the group consisting of LiMO₂ layer structures with preferably M=Ni, Co, Mn and/or Al, in particular LiCo oxides (LCO), Li(Ni/Co) oxides (LNCO), Li(Ni/Co/Mn) oxides (LNCMO), Li(Ni/Co/Al) oxides (LNCAO), Li(Ni/Al) oxides (LNAO), Li(Ni/Mn) oxides (LNMO), or LiM₂O₄ spinel structures with preferably M=Ni, Co and/or Mn, optionally with Al doping, or pure or doped LiFe phosphates, or any mixtures thereof.

The composition particularly preferably contains or is obtained from at least one of the compounds, which is selected from the group consisting of LCOs, in particular LiCoO₂, NMCs, in particular LiNiₓMn_{y}CO₂O₂ with x+y+z=1, NCAs with LiNiₓCO_{y}Al₂O₂ with x+y+z=1, especially LiNi_{0.8}CO_{0.15}Al_{0.05}O₂, as well as LiMn₂O₄ spinels and LFP, especially LiFePO₄.

In a preferred embodiment, the composition also contains graphite, preferably in an amount of no more than 60% by weight, more preferably no more than 45% by weight, especially 10 to 45% by weight, particularly preferably 20 to 40% by weight, each based on the total weight of the composition.

In an alternatively preferred embodiment, the composition is essentially free of graphite, whereby the proportion of graphite in the composition is preferably less than 5% by weight, particularly preferably less than 2% by weight and in particular less than 1% by weight, each based on the total weight of the composition.

In the battery technology, there are a number of doping elements that, depending on the intended use, extend over various elements of the main and subgroups of the periodic system. Therefore, an embodiment is preferred, in which the composition also has doping elements, in particular those from the group of alkaline earth metals (magnesium, calcium, strontium, barium), scandium, yttrium, the titanium group (titanium, zirconium, hafnium), the vanadium group (vanadium, niobium, tantalum), the group of lanthanoids or combinations thereof.

In order to achieve better separation of the individual components of the composition, it can be subjected to a pretreatment before the reduction provided according to the invention, for example to remove electrolyte residues or to remove the graphite.

Therefore, an embodiment is preferred, in which the composition is subjected to a pretreatment. In this way, for example, electrolyte residues or graphite residues can be removed. The pretreatment is preferably heating, drying, crushing, grinding, sorting, sieving, classifying, oxidizing, sedimenting, floating, washing and filtering or combinations thereof.

In a preferred embodiment, the pretreatment consists of washing. In particular, electrolyte residues can be removed in this way.

Preferably, water or an aqueous solution is used as the washing medium for washing the lithium (I)-containing composition. In particular, the electrolyte solution can be removed in this way. Basic washing has proven particularly efficient. Therefore, preferably a basic aqueous solution is used, wherein the pH of the washing medium is preferably adjusted by adding a basically reacting inorganic compound, preferably alkali and/or alkaline earth hydroxides, and more preferably sodium hydroxide, lithium hydroxide, or ammonia.

The washing medium preferably has a pH of more than 5, more preferably the pH of the washing medium ranges from 5 to 14. The washing is preferably performed at a temperature of 10 to 120° C., more preferably 10 to 70° C.

In an also preferred embodiment, the washing is followed by a drying step, preferably at a temperature of 60 to 200° C., more preferably 80 to 150° C.

In a preferred embodiment, the washed composition is essentially free, preferably free, of fluorine-containing compounds and/or compounds of phosphorus. Preferably, the content of fluorine-containing compounds in the composition is less than 2% by weight, more preferably less than 1% by weight, especially less than 0.5% by weight, respectively based on the total weight of the composition. In a further preferred embodiment, the content of compounds of phosphorus in the composition is less than 0.2% by weight, preferably less than 0.1% by weight, respectively based on the total weight of the composition.

In a likewise preferred embodiment, the pretreatment consists of drying.

In a further preferred embodiment, the pretreatment consists of an oxidative treatment. In particular, graphite contained in the composition can be removed in this way. Alternatively or additionally, graphite can also be separated from the composition by flotation and/or sedimentation. Therefore, a further embodiment is preferred, in which a flotation and/or sedimentation is carried out as pretreatment.

Also, several pretreatments may be combined within the scope of the method according to the invention.

The composition is preferably in the form of a powder. Therefore, an embodiment is preferred, in which the composition is ground, preferably to a particle size of less than 200 μm, particularly preferably less than 100 μm, determined in accordance with ASTM B822.

Within the framework of the method according to the invention, the composition is brought together with a reducing agent in an aqueous or organic suspension medium, whereby alcohols are particularly preferred as the organic suspension medium. Water is particularly preferably used. The temperature of the suspension is preferably set to 20 to 300° C., preferably 90 to 250° C., more preferably 90 to 250° C., especially 200 to 250° C. or 20 to 120° C. Depending on the suspension medium selected, the reduction can be carried out in a conventional agitation reactor or in an autoclave with a stirring device.

The method according to the invention is preferably performed under mild conditions. In a preferred embodiment, the suspension has a pH of higher than 2, especially higher than 4.

Surprisingly, it has been found that the addition of precipitants for precipitating sparingly soluble transition metal compounds, which is necessary in conventional methods, may be omitted. Therefore, an embodiment of the method according to the invention is preferred in which the reduction of the transition metals and the leaching of the lithium take place in the same process step, wherein the transition metals remain in the form of their oxides and/or hydroxides, which are sparingly soluble in the digestion medium or suspension medium, without the addition of additional stoichiometric amounts of precipitants. In contrast to reduction, “leaching” means the treatment with a solvent that is capable of dissolving a metal compound from a solid without the solvent itself being subject to change, especially in terms of its oxidation state.

Within the framework of the method according to the invention, the composition is treated with a reducing agent. Without being bound by theory, it is assumed that treatment with the reducing agent generates a Li(I) species that is soluble in the suspension medium, while the other metals, such as cobalt, nickel and manganese, remain in the form of a solid reduced material. The fundamental process could be described, without limitation, in an exemplary manner for sulfur in the oxidation state +IV as a reducing agent by the following overall chemical equations with M=Co, Ni, Mn in an oxidation state of +III, in an exemplary manner for different variants:

$$2 {LiMO}_{2} + {SO}_{2} \to {Li}_{2} {SO}_{4} + 2 MO \qquad ( 1 )$$

$$2 {LiMO}_{2} + {LiHSO}_{3} \to {Li}_{2} {SO}_{4} + LiOH + 2 MO \qquad ( 2 )$$

In the case where M is converted to the divalent hydroxides, it is considered that the reaction can be represented in an exemplary way by the following reaction equations:

$$2 {LiMO}_{2} + {SO}_{2} + 2 {H}_{2} O \to {Li}_{2} {SO}_{4} + 2 {M ( OH )}_{2} \qquad ( 3 )$$

$$2 {LiMO}_{2} + {LiHSO}_{3} + 2 {H}_{2} O \to {Li}_{2} {SO}_{4} + LiOH + 2 {M ( OH )}_{2} \qquad ( 4 )$$

Thus, the method according to the invention overcomes the procedure, which is common in the prior art, that all elements are dissolved at first, and the metals are precipitated again in a subsequent step. Thus, within the scope of the method according to the invention, the additional precipitation step may be dispensed with, and the use of additional precipitation reagents is dispensable. Therefore, in a preferred embodiment, step b) of the method according to the invention comprises the in-situ production of a soluble Li(I) species and a solid reduced material comprising Ni, Co and Mn by treating the suspension with a reducing agent.

Organic compounds such as alcohols, aldehydes, amines or ketones, but also reducing gases, can be used as reducing agents.

In a preferred embodiment, the reducing agent is selected from the group consisting of sulfur compounds, in which sulfur is in the oxidation state+IV; aluminum; lithium; iron; iron compounds, in which iron is in the oxidation state+II; zinc; hydrazine; hydrogen or mixtures thereof.

The sulfur compounds, in which the sulfur is in the oxidation state+IV, are in particular selected from the group consisting of SO₂, Li₂SO₃, LiHSO₃, Na₂SO₃, NaHSO₃, K₂SO₃, KHSO₃, (NH₄)₂SO₃ and NH₄HSO₃.

Among the listed sulfur compounds, SO₂ has proven to be particularly efficient, so that an embodiment, in which the reducing agent is SO₂, is particularly preferred.

The metals that can be used as reducing agents are preferably recovered and reprocessed metals. In this way, a further contribution to sustainability and the reuse of raw materials can be made.

Therefore, an embodiment is preferred, in which the reducing agent is aluminum, preferably from shredded battery housings.

Alternatively, an embodiment is preferred, in which the reducing agent is zinc, preferably from waste of galvanized containers from the food industry.

In addition to sulfur compounds and metals, other compounds can also be used as reducing agents. Thus, an embodiment is preferred, in which the reducing agent is selected from the group consisting of alcohols, amines, ketones and aldehydes. In particular, the use of alcohols offers the advantage that these may be employed both as reducing agents and as the suspension medium, so that this is another contribution to a sustainable and resource-saving process.

Within the framework of the present invention, it was surprisingly found that the use of hydrazine as a reducing agent gives a reduced material, in which nickel and cobalt are present in metallic form, which in particular significantly facilitates the separation of manganese. Therefore, an embodiment is particularly preferred, in which hydrazine is used as the reducing agent.

In a further preferred embodiment, hydrogen is used as the reducing agent, in which case the reduction is preferably carried out at elevated pressure in an autoclave.

The reduction can also be carried out in a roller cathode cell.

In a preferred embodiment, the reducing agent is a component of the composition and/or can be generated in situ. This is preferred, in particular, in those cases where the composition contains graphite, which may serve as a reducing agent itself or in the form of its reaction products. Accordingly, an embodiment is preferred in which graphite is employed as a reducing agent.

By reducing the composition according to the invention, the lithium contained accumulates in the suspension medium, preferably in water, whereas the other elements such as cobalt, nickel and manganese remain in the solid reduced material.

In a preferred embodiment, the solid reduced material contains one or more of the compounds that are selected from the group consisting of nickel metal, cobalt metal, Ni(II) compounds, Co(II) compounds and/or Mn(II) compounds, whereby additionally aluminum oxide and/or aluminum hydroxide can be included.

According to the method according to the invention, a solid reduced material and a lithium(I)-containing solution are obtained, which can be further processed separately from one another in the further course. Therefore, the method according to the invention further comprises a separation step, in which a liquid phase containing lithium dissolved therein and a solid filtration residue are obtained.

The separation step is preferably a filtration, centrifugation or a sedimentation-based method, in which a liquid phase containing lithium dissolved therein and a solid residue are obtained.

Therefore, the method according to the invention offers the advantage that the lithium compounds can be further processed separately from the remaining residue, so that relatively high concentrations of the lithium-containing compound can be achieved, whereby on the one hand, the recovery of the lithium can be operated very economically and on the other hand, the lithium is not dragged along through the entire subsequent method steps for cleaning and separating the residue.

In the following, the separate reprocessing of the liquid phase and the residue will be discussed in more detail.

### i) Liquid Phase

The lithium is preferably present in the liquid phase in the form of a water-soluble compound, in particular in a form selected from the group consisting of lithium hydroxide, lithium hydrogen carbonate and lithium sulfate.

Depending on the composition and method used, the liquid phase can contain aluminum compounds soluble in the liquid phase, in addition to the lithium compounds. Therefore, an embodiment is preferred, in which the liquid phase also contains aluminum compounds.

In a preferred embodiment, the liquid phase is subjected to a further treatment to isolate the lithium. The lithium is preferably extracted from the liquid phase by precipitation, preferably by means of carbonation. The carbonation is preferably carried out by reaction with Na₂CO₃ or CO₂.

Any aluminum compounds present in the liquid phase are preferably precipitated in the form of aluminum hydroxide by adjusting the pH accordingly.

In a preferred embodiment, lithium and aluminum dissolved in the liquid phase are separated from one another by treatment with CO₂.

In a preferred embodiment, the lithium is at least partially in the form of its hydroxide and any aluminum present as lithium aluminate. In these cases, lithium and aluminum are preferably separated by treating the liquid phase with CO₂. In this way, if the method is carried out appropriately, the aluminum can be precipitated in the form of aluminum hydroxide in a first step, whereas the lithium remains in solution in the form of lithium hydrogen carbonate. This can then be isolated in a subsequent step in the form of lithium carbonate. Surprisingly, the separation could be carried out in this way without any significant losses of Li₂CO₃ being observed.

In an alternatively preferred embodiment, the lithium is at least partially in the form of a salt of a mineral acid, preferably as sulfate, and any aluminum present as Al₂(SO₄)₃. In these cases, the aluminum is preferably first precipitated as Al(OH)₃ by partial neutralization or appropriate adjustment of the pH value, then separated off and washed and separated from the lithium in this way.

### ii) Residue

In particular, the elements cobalt, nickel, manganese and possibly aluminum remain as solid residues. Therefore, an embodiment is preferred, in which the residue contains one or more of the elements selected from the group consisting of nickel, cobalt, manganese, their alloys, their oxides and their hydroxides and mixtures thereof, whereby the elements can also be in the form of mixed oxides or mixed hydroxides.

In order to isolate the elements remaining in the residue, in a preferred embodiment, the residue is subjected to further separation processes in order to separate it into its components. The further reprocessing depends on the form, in which the elements are present in the residue, whereby various methods can also be combined with one another. The expert is aware that the residue is not limited to the embodiments described below and that these are only intended to provide the expert with an advantageous teaching on how the elements nickel, cobalt, manganese and possibly aluminum remaining in the residue can be extracted.

In a preferred embodiment, the residue contains one or more of the elements selected from the group consisting of nickel, cobalt, manganese, their alloys, their oxides, their hydroxides or mixtures thereof.

In a preferred embodiment, the residue comprises the following:
Nickel in the oxidation state+II and/or 0, particularly preferably in the oxidation state 0;
Cobalt in the oxidation state+II and/or 0, particularly preferably in the oxidation state 0;
Manganese in oxidation state+II
if necessary, aluminum in the oxidation state+III.

In a further preferred embodiment, the residue preferably has less than 5% by weight of lithium, particularly preferably less than 1% by weight of lithium and in particular less than 0.5% by weight of lithium and very particularly less than 0.1% by weight of lithium, each based on the total weight of the residue.

In a particularly preferred embodiment, the residue contains or consists of nickel and cobalt in metallic form and manganese in the form of its oxide and/or hydroxide.

In a preferred embodiment, the residue is further processed with the help of at least one of the methods selected from the group consisting of treatment with mineral acids, magnetic separation methods, sedimentation, filtration, solvent extraction or pH-controlled precipitation.

For those cases, in which the elements are essentially present in the form of their hydroxides, it has proven advantageous to treat the residue with mineral acids. In this way, the elements can be brought into solution in the form of their corresponding salts and thus extracted. Mineral acids are preferably hydrochloric acid or sulfuric acid. Therefore, an embodiment is preferred, in which the filtration residue is treated with mineral acids. From the solution thus obtained, aluminum can be precipitated and separated in the form of its hydroxide by adjusting the pH accordingly, whereas the other elements nickel, cobalt and manganese remain in the solution. The remaining elements can then be separated e.g. by means of solvent extraction. Therefore, an embodiment is preferred, in which the residue is treated with a mineral acid, the solution obtained is preferably adjusted to a pH of 2 to 5, in particular 3 to 4, in order to precipitate aluminum in the form of its hydroxide, the precipitate obtained is separated off and the remaining liquid phase is subjected to a solvent extraction.

In an alternatively preferred embodiment, the liquid phase obtained is further treated with an oxidizing agent, preferably H₂O₂, while observing the pH value. In this way, the manganese contained in the liquid phase can be separated, whereas the elements nickel and cobalt remain in solution. The elements nickel and cobalt remaining after separating the manganese can be separated in further steps and used to produce pure nickel and cobalt compounds or used to precipitate hydroxidic or carbonate precursors for the production of cathode material for lithium batteries, especially LIBs. Therefore, an embodiment is preferred, in which the residue is treated with a mineral acid, the solution obtained is preferably adjusted to a pH of 2 to 5, in particular 3 to 4, in order to precipitate aluminum in the form of its hydroxide, the precipitate obtained is separated off and the remaining liquid phase is treated with an oxidizing agent, preferably H₂O₂, while observing the pH value, in order to separate manganese, the precipitate obtained is separated off and the remaining liquid phase is further processed for further separation of nickel and cobalt.

For those cases, in which the elements nickel and cobalt are present in the residue in their metallic form and manganese and aluminum in the form of their oxides and/or hydroxides, it has proven advantageous to convert the residue into a preferably aqueous suspension, from which the elements nickel and cobalt are separated in metallic form from the Al- and Mn-containing solution. The elements manganese and aluminum remaining in solution can then be extracted using known methods. Therefore, an embodiment is preferred in which the residue is converted into a, preferably aqueous, suspension by treatment with mineral acid, and the elements nickel and cobalt remain in the filtering residue in metallic form, and are subsequently dissolved completely also in mineral acids under more strongly acidic conditions.

For those cases, in which aluminum is present in the residue in the form of its hydroxide, it has proven advantageous to extract the aluminum by alkali leaching and to separate off the metals. Therefore, an embodiment is preferred, in which the residue is subjected to an alkaline leaching.

The method according to the invention gives lithium in the form of its salt or hydroxide, which can be present in highly concentrated solutions. Correspondingly, the lithium obtained with the help of the method according to the invention can be fed into the material cycle for further use. Therefore, the present invention also provides the use of the lithium obtained according to the invention in the production of lithium batteries, rechargeable lithium batteries and lithium accumulators, rechargeable lithium-ion batteries and lithium-ion accumulators and/or rechargeable lithium polymer batteries and lithium polymer batteries and other lithium containing electrochemical cells.

The use of the lithium obtained with the help of the method according to the invention for the production of lithium metal and/or lithium oxide is also preferred.

Another preferred use of the lithium obtained with the help of the method according to the invention is its use in the glass and ceramic industry, as a melt additive in aluminum production and/or as a flux in enamel production as well as in the production of antidepressants.

The present invention is to be illustrated using the following example and the following figures, whereby these are in no way to be understood as a restriction of the invention concept.

Within the scope of the following examples, the following analytical methods are employed as stated:
Inductively coupled plasma optical emission spectrometry: Li
Pyrohydrolysis, potentiometry: F
Combustion analysis: C
Carrier gas hot extraction: O
X-ray fluorescence analysis: Al, Co, Cu, Fe, Mn, Ni, P

### EXAMPLE 1

1000 g of an exemplary metallurgical composition LiNi_{1/3}Co_{1/3}Mn_{1/3}O₂ in powder form was suspended in water and flowed through with SO₂. More water was added to the suspension and the mixture was stirred, until lithium was completely in solution, whereby the pH was kept above 4. The results are summarized in Table 1. For comparison, the “conventional” column on the right in Table 1 shows the values obtained with the help of a conventional method, as shown for example in FIG. 1. The values in brackets denote the insoluble residue in each case, denoted by M=Ni, Co, Mn.

TABLE 1

| | |
|---|---|
| according to the invention | conventional |

| Suspension | 2.2 | l | Suspension | — | |
|---|---|---|---|---|---|
| Solid | 348 | g/l | Solid | — | |
| (M) | 272 | g/l | (M) | — | |
| LiOH | — | | LiOH | — | |
| Li₂SO₄ | 260 | g/l | Li₂SO₄ | — | |
| Solution | 2.1 | l | Solution | 10.4 | l |
| MeSO₄ | — | | MeSO₄ | 154 | g/l |
| (M) | — | | (M) | 58 | g/l |
| LiOH | — | | LiOH | — | |
| Li₂SO₄ | 276 | g/l | Li₂SO₄ | 55 | g/l |
| (Li) | 34.9 | g/l | (Li) | 6.9 | g/l |

The comparison in the table shows the clear improvement that the method according to the invention achieves over the conventional method. It can thus be clearly seen that, according to the conventional method, the transition metals are in solution together with lithium, whereas the method according to the invention allows the transition metals to be separated off in the form of solids, whereas lithium remains in solution. The table also shows the increased Li concentration achieved with the method according to the invention. In the conventional method, the Li concentration is lower by a factor of 5 and naturally the transition metals are present in a molar ratio of 1 to 1 in relation to Li, corresponding to the starting compound.

### EXAMPLE 2

### Step a): Suspending

150 g of a black mass washed with water and having the composition

Li (3.32% by weight), Al (1.12% by weight), Co (3.65% by weight), Cu (1.36% by weight), Fe (<0.1% by weight), Mn (2.15% by weight), Ni (22.64% by weight), P (<0.01% by weight), F (1.4% by weight), C (45.20% by weight), based on the total weight of the composition,

was suspended in 1100 ml of fully desalted water with stirring in an autoclave at room temperature.

### Step b): Treating the Suspension in the Presence of a Reducing Agent

Without adding an additional reducing agent, the carbon already contained in the black mass was utilized as a sole reducing agent. The suspension was heated at 220° C. within 90 minutes. The temperature was controlled to a set point and kept constant for 30 minutes. The pressure of about 23 bar did not change over this holding time. The suspension obtained was cooled down to 50° C. by jacket cooling within 90 minutes.

### Step c): Separating the Solid Reduced Material

The cooled suspension obtained in step b) was filtered, and the residue was washed with a total of about 600 ml of fully desalted water. The filtrate and washing water were combined and filled up to 2000 ml. The 211.31 g of filter cake obtained was dried at 105° C. until the weight remained constant to obtain 138.47 g of dried residue.

The filtrate obtained contained 1.82 g/l of Li, and the residue obtained had an Li content of 0.79% by weight. Based on these analyses, an Li dissolution yield of 73.1% or 78.0%, respectively, is obtained, based on the Li contents in the filtrate and in the residue.

### EXAMPLE 3

### Step a): Suspending

20 g of LiCoO₂ having the analyzed composition of

Li (7.44% by weight), and Co (59.94% by weight), based on the total weight of the composition,

was suspended in 986 ml of fully desalted water with stirring in an autoclave at room temperature.

Step b): Treating the Suspension with a Reducing Agent

The suspension obtained in step a) was admixed with 224.78 g of a 4.04% LiHSO₃ solution. The suspension was heated to 220° C. within 90 minutes. The temperature was controlled to a set point and kept constant for 18 hours. The pressure of about 23 bar did not change over this holding time. The suspension obtained was cooled down to 50° C. by jacket cooling within 90 minutes.

### Step c): Separating the Solid Reduced Material

The cooled suspension obtained in step b) was filtered, and the residue was washed with a total of about 600 ml of fully desalted water. The filtrate and washing water were combined and filled up to 2000 ml. The 19.21 g of filter cake obtained was dried at 105° C. until the weight remained constant to obtain 15.9 g of dried residue.

The filtrate obtained contained 1.08 g/l of Li, and the residue obtained had an Li content of 0.1% by weight. Based on these analyses, an Li dissolution yield of 97.0% or 98.9%, respectively, is obtained, based on the Li contents in the filtrate and in the residue.

### EXAMPLE 4

150 g of a black mass washed with water and having the composition

Li (3.32% by weight), Al (1.12% by weight), Co (3.65% by weight), Cu (1.36% by weight), Fe (<0.1% by weight), Mn (2.15% by weight), Ni (22.64% by weight), P (<0.01% by weight), F (1.4% by weight), C (45.20% by weight), based on the total weight of the composition,

was suspended in 470 ml of fully desalted water with stirring in an autoclave at room temperature.

### Step b): Treating the Suspension in the Presence of a Reducing Agent

The suspension obtained in step a) was admixed with 731.1 g of a 4.04% LiHSO₃ solution. The suspension was heated to 220° C. within 90 minutes. The temperature was controlled to a set point and kept constant for 90 minutes. The pressure of about 23 bar did not change over this holding time. The suspension obtained was cooled down to 50° C. by jacket cooling within 90 minutes.

### Step c): Separating the Solid Reduced Material

The cooled suspension obtained in step b) was filtered, and the residue was washed with a total of about 600 ml of fully desalted water. The filtrate and washing water were combined and filled up to 2000 ml. The 237.07 g of filter cake obtained was dried at 105° C. until the weight remained constant to obtain 143.78 g of dried residue.

The filtrate obtained contained 3.66 g/l of Li, as well as <0.01 g/l of Co, <0.01 g/l of Ni, <0.01 g/l of Mn, and the residue obtained had an Li content of <0.01% by weight. Based on these analyses, an almost quantitative Li dissolution yield is obtained, based on the Li content in the filtrate, and 99.7% is obtained, based on the Li content in the residue.

### DESCRIPTION OF THE FIGURES

FIG. 1 shows the schematic sequence of a conventional separation method, as it is used in the reprocessing of battery waste, in particular for the recovery of the elements cobalt, nickel, manganese and lithium. First, a metallurgical composition is brought into solution by acidic digestion with H₂SO₄ and the elements are precipitated one after the other. As can be seen in the overview, the elements cobalt and nickel are extracted in a joint precipitation, followed by manganese and lithium. The method has the disadvantage that lithium is separated off as the last element and is thus present as an interfering element in the previous precipitations.

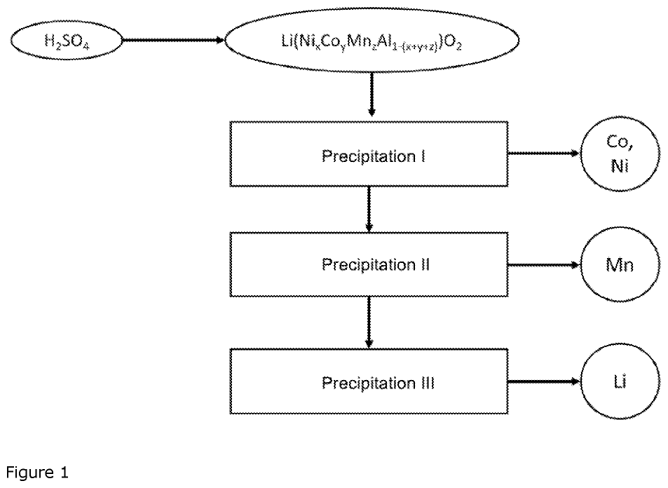

FIG. 2 shows the schematic sequence of a conventional separation method, as it is used in the reprocessing of battery waste, in particular for the recovery of the elements cobalt, nickel, manganese and lithium. First, a metallurgical composition is brought into solution by acid digestion with H₂SO₄ and the elements manganese, cobalt and nickel are separated by successive solvent extractions. Here, lithium is also extracted from the residue of the previous reactions, which leads to a significant loss in yield.

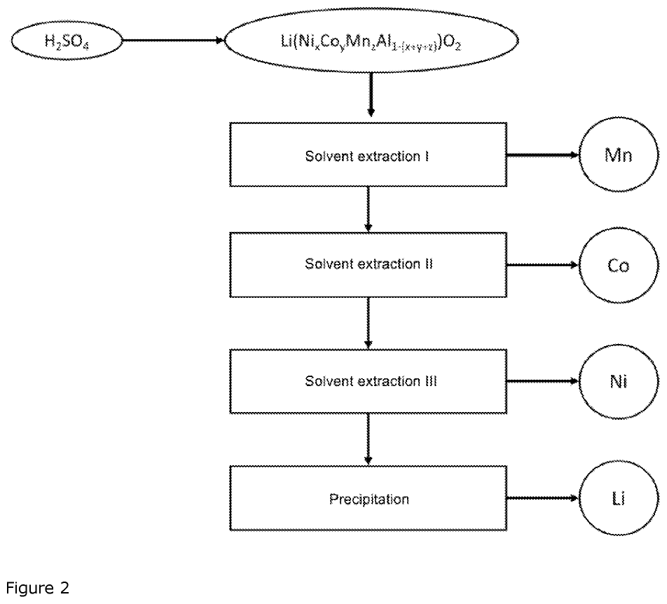

FIG. 3 shows a schematic overview of an exemplary embodiment of the method according to the invention, in which an exemplary composition is suspended in water and reduced with SO₂, so that lithium goes into solution in the form of Li₂SO₄. Filtration of the solid gives a residue I, which contains nickel, cobalt and manganese, and a filtrate II, which contains the dissolved Li₂SO₄. This is precipitated in the form of its carbonate by adding Na₂CO₃. After separating the lithium, the further processing and separation of nickel, cobalt and manganese can take place without the disruptive effects of lithium.

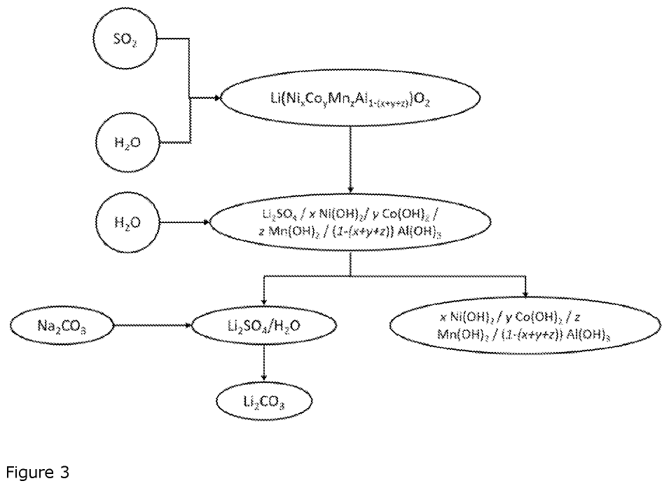

The method according to the invention, as described in FIG. 3, offers various starting points, at which the valuable materials can be returned to the valuable material cycle. For example, the lithium sulfate solution (filtrate II) can be electrolytically broken down into LiOH lye and dilute sulfuric acid at a Li producer. The Li producer then extracts solid LiOH*H₂O from the LiOH lye for reuse in the production of cathode materials, in particular NCA cathode materials, and returns the sulfuric acid to the processors of transition metals. In this way, a sustainable cycle can be established.

FIG. 4 shows a further schematic overview of another exemplary embodiment of the method according to the invention with the corresponding stoichiometry, in which hydrazine (N₂H₄) is used as the reducing agent. Within the framework of the example according to the invention, a composition is suspended in water and hydrazine is added. After adding more water and filtration, a filtrate I is obtained, which contains lithium hydroxide and lithium aluminate in dissolved form, whereas the separated residue I contains nickel and cobalt in metallic form and manganese in the form of its hydroxide. Therefore, already in a first separation step, lithium and aluminum can be effectively separated off from the other components of the composition. In a further step, the filtrate I is mixed with sulfuric acid in order to precipitate aluminum in the form of its hydroxide. A simple filtration thus provides a solution of lithium sulfate (filtrate II), which can be reintroduced into the valuable material cycle, for example for the production of LIBs, and aluminum hydroxide in solid form (residue II), which can also be used for further purposes. By treating residue I with sulfuric acid, the manganese hydroxide is converted into soluble manganese sulphate, so that further filtration provides nickel and cobalt in metallic form (residue III) and a solution with manganese sulphate (filtrate III), which can be added for separate further processing.

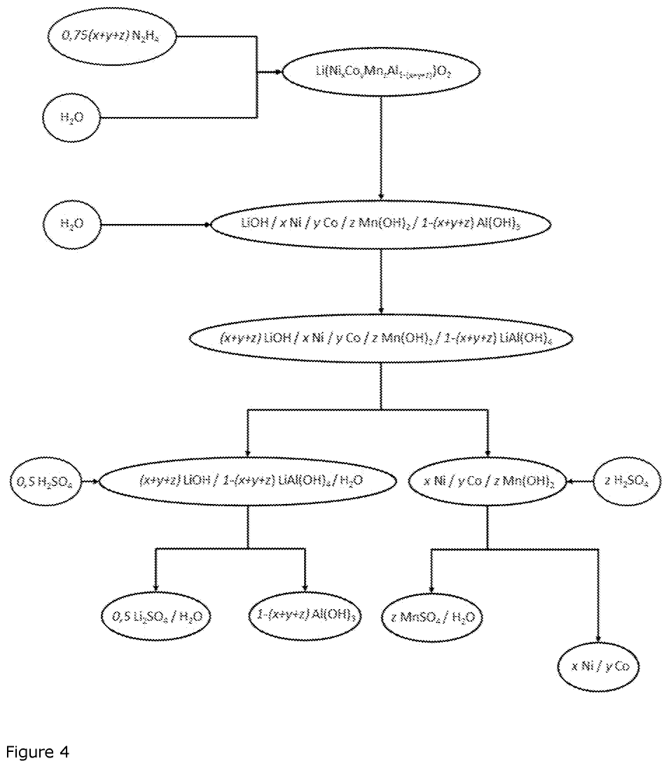

FIG. 5 shows an exemplary reprocessing of the aqueous filtrate obtained after leaching, in which lithium is present in the form of its hydroxide and aluminum in the form of lithium aluminate (filtrate I), as is obtained, for example, in the process described in FIG. 4. The filtrate I is mixed with a suitable amount of CO₂ in deficit and the lithium carbonate formed is separated off (residue II), whereby a filtrate II is obtained. By adding more CO₂, lithium hydroxide and lithium aluminate remaining in filtrate II are separated, whereby the addition is controlled in such a way that the aluminate is precipitated in the form of its hydroxide and then filtered off (residue III), whereas lithium remains in solution in the form of lithium hydrogen carbonate (filtrate III), which is converted into lithium carbonate by heating and thus precipitated. The resulting CO₂ can be fed back into the cycle. In this way, an efficient and simple separation of lithium and aluminum from the filtrate I is achieved.

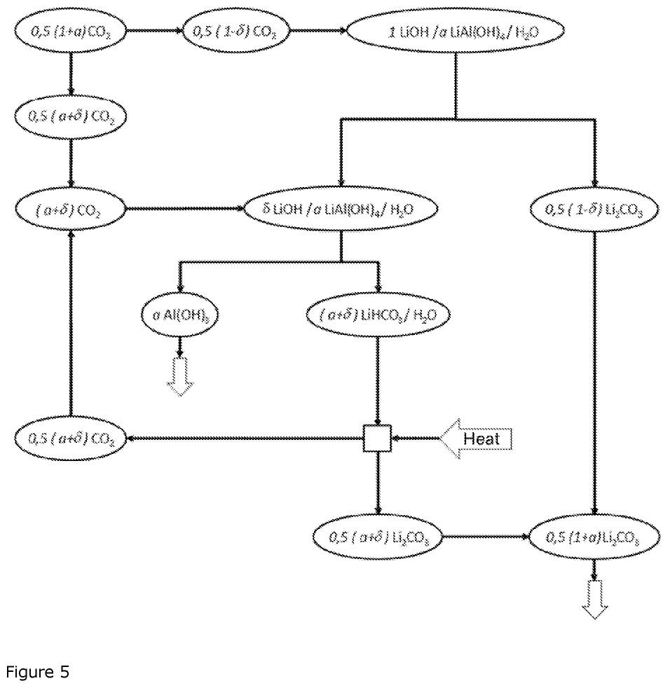

FIG. 6 shows an alternative extraction of aluminum and lithium from the filtrate I obtained according to the invention. The filtrate I is mixed with excess CO₂, so that aluminum is precipitated in the form of its hydroxide (residue II), whereas the lithium remains in solution in the form of lithium hydrogen carbonate (filtrate II). After the aluminum hydroxide has been filtered off, the remaining solution can be heated, through which the lithium hydrogen carbonate changes into lithium carbonate and precipitates. The resulting CO₂ can be fed back into the cycle.

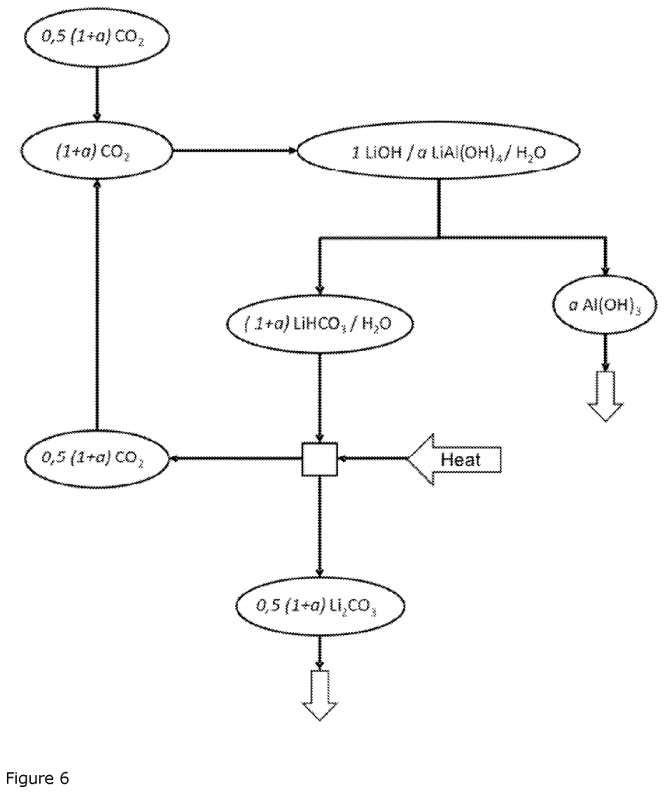

As clearly shown in the figures, the method according to the invention offers a simple and sustainable way of recovering the various valuable materials from the active materials of used batteries. Costly handling of liquid metallic phases and slag is therefore no longer necessary.

1. A method of recycling LIB materials, comprising the following steps:
a) suspending a lithium(I)-containing composition in an aqueous or organic suspension medium,
b) treating the suspension with a reducing agent to simultaneously obtain a solid reduced material and a lithium(I)-containing solution and
c) separating the solid reduced material from the lithium(I)-containing solution.

2. The method according to claim 1, characterized in that step b) includes the in-situ production of a soluble Li(I) species and a solid reduced material comprising Ni, Co and Mn by treating the suspension with a reducing agent.

3. The method according to claim 1, characterized in that the temperature of the suspension is adjusted to 20 to 300° C.

4. The method according to claim 1, characterized in that the separation of the lithium takes place before the separation of nickel, cobalt and manganese.

5. The method according to claim 1, characterized in that the composition and/or the reduced material is in the form of a powder.

6. The method according to claim 1, characterized in that the composition is obtained from or consists of used LIBs, production waste, secondary yields, or a combination thereof that arise in the production of LIBs.

7. The method according to claim 1, characterized in that the composition is black mass.

8. The method according to claim 1, characterized in that the composition contains lithium in an amount of 1 to 20% by weight, based on the total weight of the composition.

9. The method according to claim 1, characterized in that the composition contains at least one of the compounds or is obtained by means of pyrolysis from this, which is selected from the group consisting of LiMO₂ layer structures with M=Ni, Co, Mn and/or Al, optionally with Al doping, or pure or doped LiFe phosphates, or any mixtures thereof.

10. The method according to claim 1, characterized in that the composition contains or is obtained from at least one of the compounds selected from the group consisting of LCOs, or NCAs with LiNiₓCo_{y}Al_{z}O₂ with x+y+z=1.

11. The method according to claim 1, characterized in that the composition is subjected to a pretreatment.

12. The method according to claim 11, characterized in that the pretreatment is heating, drying, crushing, grinding, sorting, sieving, classifying, oxidizing, sedimenting, floating, washing and filtering or combinations thereof.

13. The method according to claim 1, characterized in that the reducing agent is a component of the composition and/or is produced in situ.

14. The method according to claim 1, characterized in that the reducing agent is selected from the group consisting of sulfur compounds, in which sulfur is in the oxidation state+IV; aluminum; lithium; iron; iron compounds, in which iron is in the oxidation state+II; zinc; hydrazine; hydrogen; or mixtures thereof.

15. The method according to claim 1, characterized in that the reducing agent is selected from the group consisting of alcohols, amines, ketones, and aldehydes.

16. The method according to claim 1, characterized in that said reducing agent is graphite.

17. The method according to claim 14, characterized in that the reducing agent is selected from compounds, in which the sulfur is in the oxidation state+IV.

18. The method according to claim 14, characterized in that the reducing agent is aluminum.

19. The method according to claim 14, characterized in that the reducing agent is zinc.

20. The method according to claim 14, characterized in that hydrogen is used as reducing agent.

21. The method according to claim 14, characterized in that the reducing agent is SO₂ or hydrazine.

22. The method according to claim 1, characterized in that the solid reduced material contains one or more of the compounds selected from the group consisting of nickel metal, cobalt metal, Ni(II) compounds, Co(II) compounds and/or Mn(II) compounds.

23. The method according to claim 1, characterized in that the separation step c) is a filtration, centrifugation or a method based on sedimentation, in which a liquid phase containing lithium dissolved therein and a solid residue are obtained.

24. The method according to claim 23, characterized in that the lithium is extracted from the liquid phase by precipitation.

25. The method according to claim 23, characterized in that lithium and aluminum dissolved in the liquid phase are separated from one another by treatment with CO₂.

26. The method according to claim 23, characterized in that the solid residue contains one or more of the elements selected from the group consisting of nickel, cobalt, manganese, their alloys, their oxides, their hydroxides or mixtures of these.

27. The method according to claim 23, characterized in that the solid residue comprises the following:
nickel in the oxidation state+II and/or 0;
cobalt in the oxidation state+II and/or 0; and
manganese in oxidation state+II.

28. The method according to claim 23, characterized in that the residue contains or consists of nickel and cobalt in metallic form and manganese in the form of its oxide and/or hydroxide.

29. The method according to claim 23, characterized in that the residue is further processed by means of at least one of the methods selected from the group consisting of treatment with mineral acids, magnetic separation methods, sedimentation, filtration, solvent extraction or pH-controlled precipitation.

30. The method according to claim 29, characterized in that the residue is treated with a mineral acid, the solution obtained is adjusted to a pH of 2 to 5 in order to precipitate aluminum in the form of its hydroxide, the precipitate obtained is separated off and the remaining liquid phase is subjected to a solvent extraction.

31. The method according to claim 29, characterized in that the residue is treated with a mineral acid, the solution obtained is adjusted to a pH of 2 to 5 in order to precipitate aluminum in the form of its hydroxide, the precipitate obtained is separated off and the liquid phase is treated with an oxidizing agent, preferably H₂O₂, while maintaining the pH value, in order to separate manganese, the precipitate obtained is separated off and the liquid phase obtained is further processed for further separation of nickel and cobalt.

32. The method according to claim 23, characterized in that the residue is converted into a aqueous suspension by treatment with mineral acid and the elements nickel and cobalt are separated off in the form of their metals.

33. The method according to claim 23, characterized in that the residue is subjected to alkaline leaching.

34. A lithium obtained by a method according to claim 1, wherein the lithium is utilized in the production of lithium batteries, rechargeable lithium batteries and accumulators, rechargeable lithium-ion batteries and lithium-ion accumulators and/or rechargeable lithium-polymer batteries and lithium-polymer accumulators and other lithium-containing electrochemical cells.

35. (canceled)

36. (canceled)
